(19) United States
(12) Patent Application Publication
(10) Pub. No.: US 2003/0214531 A1
(43) Pub. Date: Nov. 20, 2003

(54) Ink input mechanisms

(75) Inventors: Robert L. Chambers, Sammamish, WA (US); Steve Dodge, Sammamish, WA (US); Kyril Feldman, Kirkland, WA (US); Arin J. Goldberg, Woodinville, WA (US); Alexander Gounares, Kirkland, WA (US); Timothy H. Kannapel, Bellevue, WA (US); Todd A. Torset, Woodinville, WA (US); Tobias Z. Zielinski, Redmond, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/183,995

(22) Filed: Jun. 28, 2002

Related U.S. Application Data
(60) Provisional application No. 60/379,749, filed on May 14, 2002.
(60) Provisional application No. 60/379,781, filed on May 14, 2002.

(51) Int. Cl. G09G 5/00

(52) U.S. Cl. 345/764

(57) ABSTRACT

Various user interfaces and processes are described for receiving electronic ink. A user may write in a first input region. In addition, a user may write in an expanded input region having a greater sized than the first region. Third, a user may write or tap keys to input ink/text from a third region including an input panel.

### RELATED APPLICATIONS

This application claims priority to U.S. Provisional Applications Serial Nos. 60/379,749 (Attorney Docket 003797.00401) and 60/379,781 (Attorney Docket 003797.87571), both filed on May 14, 2002, both entitled, “Interfacing with Ink,” both expressly incorporated by reference herein as to their entire contents including their appendices.

### FIELD OF THE INVENTION

Aspects of the present invention are directed generally to interfaces between software applications and/or data structures. More particularly, aspects of the present invention are directed to input processes for capturing and/or editing of electronic ink.

### BACKGROUND

Typical computer systems, especially computer systems using graphical user interface (GUI) systems such as Microsoft WINDOWS, are optimized for accepting user input from one or more discrete input devices such as a keyboard for entering text, and a pointing device such as a mouse with one or more buttons for driving the user interface. The ubiquitous keyboard and mouse interface provides for fast creation and modification of documents, spreadsheets, database fields, drawings, photos and the like. However, there is a significant gap in the flexibility provided by the keyboard and mouse interface as compared with the non-computer (i.e., standard) pen and paper. With the standard pen and paper, a user edits a document, writes notes in a margin, and draws pictures, other shapes, and the like. In some instances, a user may prefer to use a pen to mark-up a document rather than review the document on-screen because of the ability to freely make notes outside of the confines of the keyboard and mouse interface.

Some computer systems permit a user to draw on a screen. For example, the Microsoft READER application permits one to add electronic ink (also referred to herein as “ink”) to a document. The system stores the ink and provides it to a user when requested. Other applications (for example, drawing applications as known in the art are associated with the Palm 3.x and 4.x and PocketPC operating systems) permit the capture and storage of drawings. In addition, various drawing applications such as Coral Draw and photo and editing applications such as Photoshop may be used with stylus based input products, such as the Wacom tablet product. These drawings include other properties associated with the ink strokes used to make up the drawings. For instance, line width and color may be stored with the ink. One goal of these systems is to replicate the look and feel of physical ink being applied to a piece of paper. However, physical ink on paper may have significant amounts of information not captured by the electronic collection of a coordinates and connecting line segments. Some of this information may include the thickness of the pen tip used (as seen through the width of the physical ink) or angle of the pen to the paper, the shape of the pen tip, the speed at which the ink was deposited, pressure of the pen tip, and the like. Another problem associated with ink includes its integration with available writing areas. For example, when filling out an electronic form using electronic ink, a user is confronted with very small input regions, as these regions are generally optimized for receiving text from a keyboard. A solution is needed that permits a variety of different types of input interfaces to be used with the existing input regions.

### SUMMARY

Aspects of the present invention provide flexible and efficient user interfaces for entering electronic ink, thereby solving one or more of the problems identified with conventional devices and systems. In some aspects of the present invention, users may write in input fields. In other aspects of the present invention, users may be presented with an expanded input field in which to enter electronic ink. Finally, an input panel (with or without a soft keyboard) may be provided to a user to capture electronic ink.

These and other features of the invention will be apparent upon consideration of the following detailed description of the embodiments.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the claimed invention.

FIG. 1 is a functional block diagram of an illustrative general-purpose digital computing environment that can be used to implement various aspects of the invention.

FIG. 2 is a plan view of an illustrative tablet computer and stylus that may be used in accordance with various aspects of the invention.

FIGS. 3-6 are various illustrative screen shots of a graphical user interface in accordance with various aspects of the present invention.

FIG. 7 shows various illustrative gestures that may be used in accordance with various aspects of the present invention.

FIG. 8 is a functional block diagram showing an illustrative system environment in accordance with various aspects of the present invention.

FIG. 9 is a functional block diagram of an illustrative application programming interface in accordance with various aspects of the present invention.

FIG. 10 shows examples of input regions in accordance with aspects of the present invention.

FIG. 11 is an additional functional block diagram of the ink edit control having additional properties in accordance with various aspects of the present invention.

FIG. 12 shows examples of boxed input regions in accordance with aspects of the present invention.

FIG. 13 shows an illustrative process for determining when inking occurs in accordance with aspects of the present invention.

FIG. 14 shows relationships between the ink edit control and additional modules in accordance with aspects of the present invention.

### DETAILED DESCRIPTION OF ILLUSTRATIVE EMBODIMENTS

Below is described a way to capture, recognize, interface with, edit or otherwise manipulate, and/or display electronic ink.

The following description is divided into sub-sections to assist the reader. The sub-sections include: terms; general-purpose computer; electronic ink and the concept of an ink object; ink collector object; ink edit control; and ink edit API.

Terms

Ink—A sequence or set of strokes with properties. A sequence of strokes may include strokes in an ordered form. The sequence may be ordered by the time captured or by where the strokes appear on a page. Other orders are possible. A set of strokes may includes sequences of strokes or unordered strokes or any combination thereof.

Stream—A sequence of strokes that may or may not include properties that comprises a data structure.

Ink object—A data structure storing a stream with or without properties, methods, and/or events.

Stroke—A sequence or set of captured points. For example, when rendered, the sequence of points may be connected with lines. Alternatively, the stroke may be represented as a point and a vector in the direction of the next point. In short, a stroke is intended to encompass any representation of points or segments relating to ink, irrespective of the underlying representation of points and/or what connects the points.

Point—Information defining a location in space. For example, the points may be defined relative to a capturing space (for example, points on a digitizer), a virtual ink space (the coordinates in a space into which captured ink is placed), and/or display space (the points or pixels of a display device).

Virtual Ink Space or Ink Space Rectangle—A framework to which all present ink strokes relate. The framework may include a two or three-dimensional shape. In one example, the framework may include a unit size square. In another example, the framework may include a defined rectangle. While some ink strokes may extend outside of the framework, the framework may be used for rendering purposes including dimensioning for a printer or a display. In one aspect, the framework is a norm to which ink strokes may be spatially defined.

Global Ink Properties—these properties apply to a stroke or set of strokes unless otherwise defined. For example, a selected ink color may be blue. By setting all strokes to blue, the default color of the strokes would be blue.

Local Ink Properties—These properties apply to a specific stroke (or data point or data points). For example, while a global ink property may be blue, a specific stroke may be set too red. Some local ink properties may be interpreted, in some cases, as global properties as they affect subsequently encountered strokes in an ink object. It is noted that properties may or may not be labeled as global or local. In some examples, the created data structure defines the scope of the properties.

Render—The process of determining how graphics (and/or ink) is to be displayed, whether on a screen or printed, or output into another file format.

General Computing Platforms

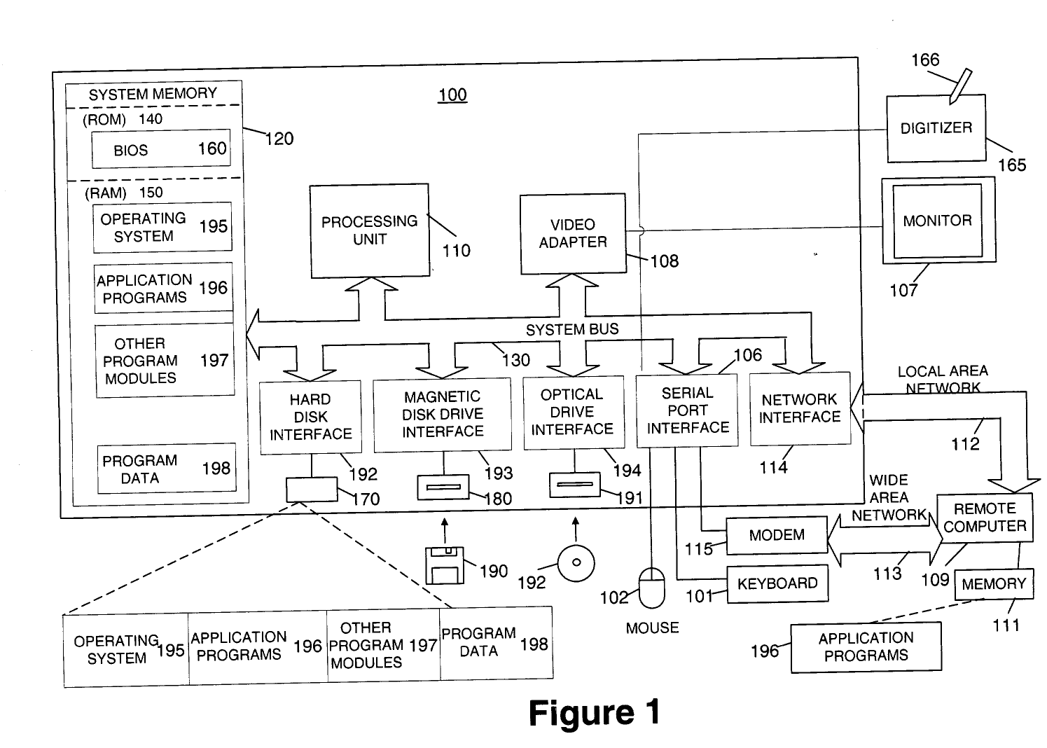

FIG. 1 is a functional block diagram of an example of a conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In a preferred embodiment, a pen digitizer 165 and accompanying pen or stylus 166 are provided in order to digitally capture freehand input. Although a direct connection between the pen digitizer 165 and the serial port is shown, in practice, the pen digitizer 165 may be coupled to the processing unit 110 directly, via a parallel port or other interface and the system bus 130 as known in the art. Furthermore, although the digitizer 165 is shown apart from the monitor 107, it is preferred that the usable input area of the digitizer 165 be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

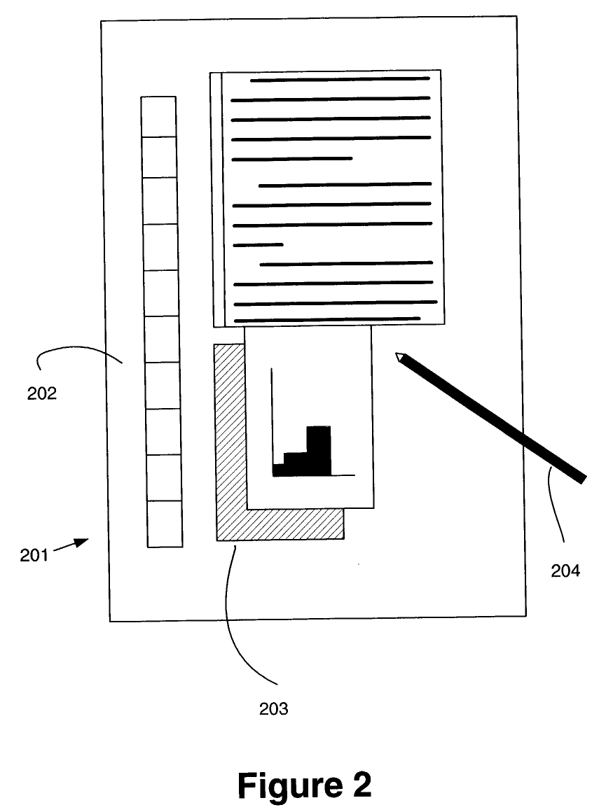

FIG. 2 shows an example of a stylus-based computer processing system (also referred to as a tablet PC) 201 that can be used in accordance with various aspects of the present invention. Any or all of the features, subsystems, and functions in the system of FIG. 1 can be included in the computer of FIG. 2. Tablet PC 201 includes a large display surface 202, e.g., a digitizing flat panel display, preferably, a liquid crystal display (LCD) or OLED screen, plasma display and the like, on which a plurality of windows 203 is displayed. Using the tip of the stylus 204 (the tip also being referred to herein as a “cursor”), a user can select, highlight, and write on the digitizing display area. Examples of suitable digitizing display panels include electromagnetic pen digitizers, such as the Mutoh or Wacom pen digitizers. Other types of pen digitizers, e.g., optical digitizers, may also be used. Tablet PC 201 interprets marks made using stylus 204 in order to manipulate data, enter text, and execute conventional computer application tasks such as spreadsheets, word processing programs, and the like.

A stylus could be equipped with buttons or other features to augment its selection capabilities. In one embodiment, a stylus could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be used for selecting or indicating portions of the displayed image on a touch-sensitive or proximity-sensitive display. Consequently, the term “user input device”, as used herein, is intended to have a broad definition and encompasses many variations on well-known input devices.

Electronic Ink and the Concept of an Ink Object

Ink as used herein refers to electronic ink. The electronic ink may be structured as a sequence or set of strokes, where each stroke includes a sequence or set of points. A sequence of strokes and/or points may be ordered by the time captured and/or by where the strokes and/or points appear on a page. A set of strokes may include sequences of strokes and/or points, and/or unordered strokes and/or points. The points may be represented using a variety of known techniques including Cartesian coordinates (X, Y), polar coordinates (r, Θ), and other techniques as known in the art. A stroke may alternatively be represented as a point and a vector in the direction of the next point. A stroke is intended to encompass any representation of points or segments relating to ink, irrespective of the underlying representation of points and/or what connects the points. Ink collection typically begins at a digitizer (such as the digitizer of the display surface 202). A user may place a stylus on the digitizer and begin to write or draw. At that point, new ink packets (i.e., packets of ink-related data) may be generated. The user may also move the stylus in the air proximate enough to the digitizer to be sensed by the digitizer. When this occurs, packets of data (called herein “in-air packets”) may be generated according to the sensed in-air movements of the stylus. Packets may include not only position information but also stylus pressure and/or angle information.

To store ink, an ink object may be created that represents the original strokes of ink drawn by the stylus 204 upon the display surface 202 and/or other input. The collected strokes of ink may be collected from anywhere on the display surface 202 or only from a defined portion thereof, such as a particular window. The Ink object is essentially a container of ink data. The particular format of how ink is stored in the ink object is not important to the present invention. It is preferable, however, that the ink strokes as originally drawn are stored in the ink object.

At least two types of ink objects may be defined. A tInk object (the “t” meaning “text”) may be embodied as an OLE object representing ink that is expected to form letters or words. The tInk object allows the handwritten ink to be converted to text, such as by a text recognizer. The tInk object may be referred to as an ink object that relates to ink and having a textual context. The color and/or font size of the textual ink, as well as whether the textual ink should be underlined, bold, italic, and/or the like may be set programmatically and may be based on the attributes of the text around the tInk object. In other words, the ambient properties at the tInk object's intended insertion point may be applied to the tInk object. In one embodiment, the tInk object contains only a single word for submission to the text recognizer, such that a sentence may contain multiple tInk objects. On the other hand, an sInk object (the “s” meaning “sketch”) may also be defined as an object representing ink that is not expected to form words. The sInk object may also be an OLE object. An sInk object may therefore be interpreted as a drawing or any other non-textual context. A sInk object may also be useful for representing multiple words. An ink-compatible application (and/or the user) may mark certain Ink objects as tInk objects and others as sInk objects. For the purposes of description, the two types of ink are described herein as “tInk” and “sInk.” It is appreciated, however, that other names may be used to represent the various types of ink object that may be used. In addition, alternative types of objects may be used to store electronic ink in any desired format.

InkCollector Object

An object (called herein an “InkCollector” object) may be defined and used to capture ink from an ink input device and/or deliver ink to an application. The InkCollector object acts, in a sense, as a funnel that channels ink into one or more different and/or distinct ink objects by collecting the ink as one or more ink strokes and storing the ink in one or more associated ink objects. The InkCollector object may attach itself to a known application window. It then may provide real-time inking on that window by using any or all available tablet devices (which may include the stylus 204 and/or a mouse). The ink may be collected as one or more ink strokes and stored in one or more associated ink objects. To use the InkCollector object, the developer may create it, assign which window to collect drawn ink in, and enable the object. After the InkCollector object is enabled, it may be set to collect ink in a variety of ink collection modes, in which ink strokes and/or gestures are collected. A gesture is a movement or other action of the stylus 204 that is interpreted not as rendered ink but as a request or command to perform some action or function. For example, a particular gesture may be performed for the purpose of selecting ink, while another gesture may be for the purpose of italicizing ink. For every movement of a stylus upon or proximate to the digitizer input, the InkCollector object will collect a stroke and/or a gesture.

InkEdit Control

A control may be defined, herein called an “InkEdit” control, that provides an easy way to capture, recognize, and/or display ink (e.g., in text form). The InkEdit control may further support displaying ink as an embedded object (e.g., as a tInk embedded object, programmatically accessible via the select ink property) with ink-formatting and/or text-formatting capabilities, such as bold, underline, italics, superscript, subscript, justification, and the like. The primary intended use of this control is to allow entry of ink and to display either the ink or the text recognized from the ink. This control may further allow editing and/or formatting of the ink and/or the recognized text.

A well-known Microsoft WINDOWS user interface is the edit control (i.e., RichEdit and RichTextBox). Embodiments of the InkEdit control provide developers an extended ink version of these controls they are already familiar with and are likely already using in their applications, and add various features to the existing RichEdit control to accept text from astylus, mouse, and/or other pointer, in addition to the existing ability to accept text from a keyboard. For example, in one embodiment, the InkEdit control provides the ability to accept electronic ink handwriting, recognize, and convert that ink to text. The InkEdit control may further provide the ability to accept handwriting as ink for later recognition, such that the handwriting itself is editable.

To use the InkEdit control, a developer need simply instantiate the InkEdit control. The developer and/or runtime user may further apply one or more modes to the InkEdit control various features. For example, one mode may indicate whether ink should be inserted as ink or text. The InkEdit control may manage many of the internal mundane details of establishing a tablet context, listening for digitizer events, collecting strokes, feeding the strokes into a recognizer, and/or feeding the results of recognition (which may be, e.g., OLE embedded objects) into the InkEdit control for display and later persistence.

In one illustrative embodiment, the InkEdit control may be implemented in ActiveX and Win32 and be based on a conventional Microsoft Win32 Rich Edit control. In another illustrative embodiment, the InkEdit control may be implemented in Microsoft .NET and be based on the Win32 InkEdit and RichEdit controls, as well as the Microsoft .NET RichTextBox control. As is well known, the Microsoft RichEdit and RichTextBox controls allow a user to enter, edit, format, print, and save text while providing various advanced formatting features (such as text font, color, formatting, etc.). The InkEdit control of the present invention may thus have many of the features provided by the RichEdit and RichTextBox controls, except that these features may now be applied to ink as well as to conventional text. Ink may become a first-class citizen in and of itself. As is the case with text that may be bolded, underlined, italicized, and the like, the InkEdit control and its programming interface may permit ink information to be manipulated as easily as text, while providing the richness of handwritten ink.

In some embodiments, the InkEdit control is designed to work well in a form scenario for single line as well as multi-line text entry and editing. The InkEdit control may get ink input from a user in the form of textual handwriting. The ink input may be recognized and printed text may be inserted in its place. The default user interface for InkEdit may resemble that of the conventional RichTextBox control, except when the user is inking. The InkEdit control may display either original ink or recognized text (or both). The displayed ink may be scaled to the current input font size of the InkEdit control and may be displayed inline with other text, and/or may otherwise be altered in its position, size, and/or color. Alternatively, the displayed ink may retain its original position, size, and/or color.

In one illustrative embodiment, the default behavior for the InkEdit control is to recognize and convert the ink into text after a brief recognition timeout has expired. This recognition timeout may be any amount of time as desired, such as about 2000 milliseconds, or in the range of about 100 milliseconds to about 5000 milliseconds, or in the range of about 200 milliseconds to about 2000 milliseconds. Where the recognition timeout is set to zero, this may disable automatic recognition. Because the InkEdit control may be a super-class of Rich Edit, it may further be possible to embed and display ink within the InkEdit control. Each ink word may be inserted into the control as an Ink object (e.g., a tInk object). The Ink object may contain the ink and one or more properties associated with the ink.

When inserted, the ink may be scaled to the current font size and other ambient properties, such as italics or bold, are applied. Should the user choose to edit the text of an Ink object, the user may first convert the ink to text.

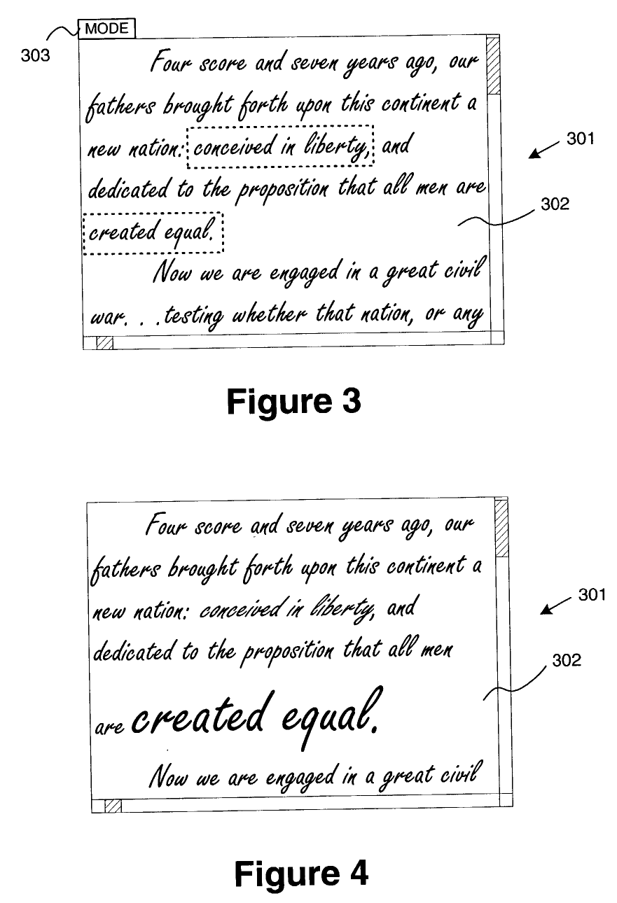

Referring to FIG. 3, the InkEdit control may appear on the display in association with a graphical user interface 301. The graphical user interface 301 may include one or more display spaces 302 for receiving drawn ink data and/or for displaying ink and/or text. The graphical user interface may receive data, such as ink data drawn by the stylus 204 in the display space 302, and the InkEdit may interpret that data as ink. The InkEdit control may further associate the ink with one or more properties such as bold, underline, italics, superscript, subscript, justification, color, size, and/or the like, as chosen by the application developer, the user, and/or automatically. As shown in FIGS. 3 and 4, some of the ink may be selected and provided a property, where, for example, the handwritten ink words “conceived in liberty” are selected and then italicized, and the handwritten ink words “created equal” are selected (shown by the broken box in FIG. 3) and then increased in size. The InkEdit control may further cause the ink and its associated properties to be stored as an ink object. Thus, for example, the ink in the display space 302 may be stored in one or more ink objects, and the words “conceived in liberty” may be stored in the ink object to be associated with an italics property. In response to the ink data being received, the InkEdit control may cause the ink to be displayed. In one embodiment, the ink is displayed in the display space 302 at, e.g., the same location(s) within the display space 302 where the ink data is received.

The ink may remain displayed (i.e., persist) within the display space 302, or the ink may be recognized and/or converted into text. This recognition and/or conversion may take place immediately, after the recognition timeout, and/or upon command (e.g., from a user or from an application). Where the ink is recognized and/or converted to text in response to a timeout condition, the recognition timeout may be for any amount of time desired, such as about 2000 milliseconds, or in the range of about 100 milliseconds to about 5000 milliseconds, or in the range of about 200 milliseconds to about 2000 milliseconds. A timer for timing the recognition timeout may start in response to the stylus 204 lifting off the display surface 202 and/or in response to a stroke ending, and may be canceled upon the stylus 204 returning to the display surface 202 before the timeout condition occurs. Other events that may cause the timer to start include the stylus 204 stopping movement upon the display surface 202, a gesture from the stylus 204, another input such as a button, and/or the like. The ink may or may not be recognized and/or displayed as printed text depending upon the setting of one or more mode switches. The one or more mode switches may be associated with one or more displayed elements (e.g., displayed element 303) or may be hidden from the user (i.e., not shown on the display). Where the switch is in a first setting, the ink will not be recognized or displayed as text. In some embodiments, the ink may still be recognized and/or displayed as text in response to a particular command. Where the switch is in a second setting, the ink may be recognized and/or displayed as text (either immediately, after a timeout, or upon command as discussed herein). Where the ink is displayed as text, the text that results from the recognition may be displayed to replace the ink in the display space 302 such that the ink being replaced is no longer displayed in the display space 302. FIG. 5 illustrates a portion of the ink in the display space 302 having been recognized and converted to text, and FIG. 6 illustrates all of the ink in the display space 302 having been recognized and converted to text. In these illustrative figures, the script writing represents the original handwritten ink and the printed font represents the recognized text.

The ink may be recognized by a single recognizer or by a plurality of recognizers, such as a collection of recognizers. The recognizers may include one or more gesture recognizers and/or text recognizers. A selection of ink to be recognized may further be associated with a particular recognition context, which may include a so-called “factoid” property, along with one or more various recognition properties. The factoid property may be considered a set of “hints” that are provided to the recognition context to assist in more accurate contextual recognition of ink. A recognizer context object may be defined that represents the ability to perform ink recognition, retrieve the recognition result, and/or retrieve alternate recognition results. The recognizer context object may enable the various recognizers installed on a system to process input appropriately by performing ink recognition. At least two types of recognition may be performed including background recognition or foreground recognition. Background recognition occurs in the background processing of the system and may be stopped due to other system events (created by the user or otherwise). In contrast, foreground recognition is generally initiated by a user and does not stop until the recognition is completed. The recognition context object may receive ink strokes that are to be recognized and the factoid property may define the constraints and/or other parameters on the input ink and the desired recognition output. For example, constraints that may be set include the language, dictionary, and/or grammar to be used during recognition. Where the InkEdit control is used in connection with a form, a different recognizer context and/or factoid may be set for each data entry field in the form. The various data entry fields may be specific to certain sets of information, such as telephone number fields having numbers, plus signs, dashes and parentheses; zip code fields having numbers and dashes only; state abbreviations having capital letters only; universal resource locators (URLs); and the like.

One potential benefit of having different recognizer contexts and/or factoids is that, in some embodiments, the time frame that recognition occurs, or what triggers recognition, may be adjusted. For example, for name or comment fields in a form, it may be desired that recognition occur at the end of each word. However, when using state, street/apartment number, or zip code fields (for example), it may be desired that recognition occur after each character is written. In some instances, this character-by-character recognition may be used to provide greater recognition accuracy than may be achieved by recognizing a group of characters together.

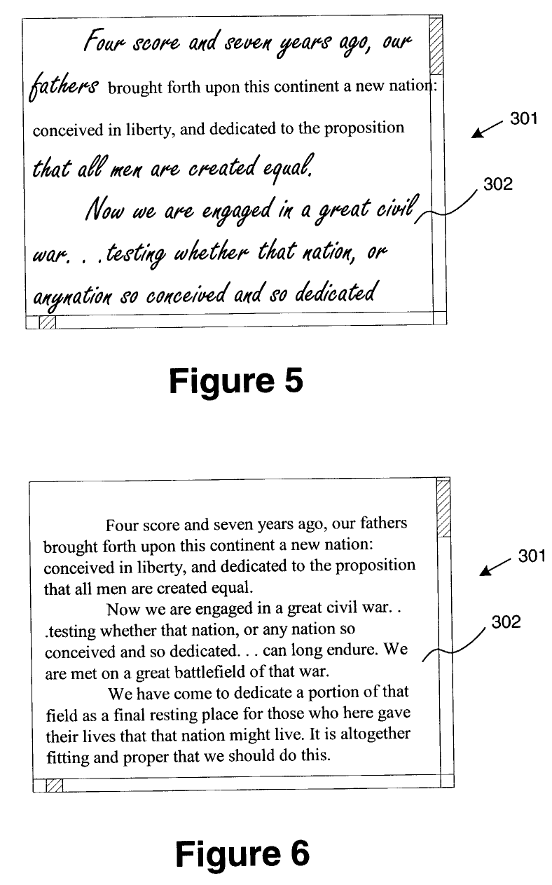

The InkEdit control may further provide gesture support, and may generate events responsive to gestures. Referring to FIG. 7, various gestures may be supported, such as the illustrative gestures 701-704 as shown. For example, gesture 701 may represent a carriage return, gesture 702 may represent a tab command, gesture 703 may represent a space character, and gesture 704 may represent a backspace command. Many other gestures are possible.

The InkEdit control may further provides a correction user interface that allows users to view alternate recognition results, use an on-screen keyboard, and/or use character, letter, and/or block text recognizers as desired. Also, the InkEdit control may allow persistence and loading of its data using the same save and load mechanisms as the conventional Windows Forms RichTextbox control.

InkEdit API

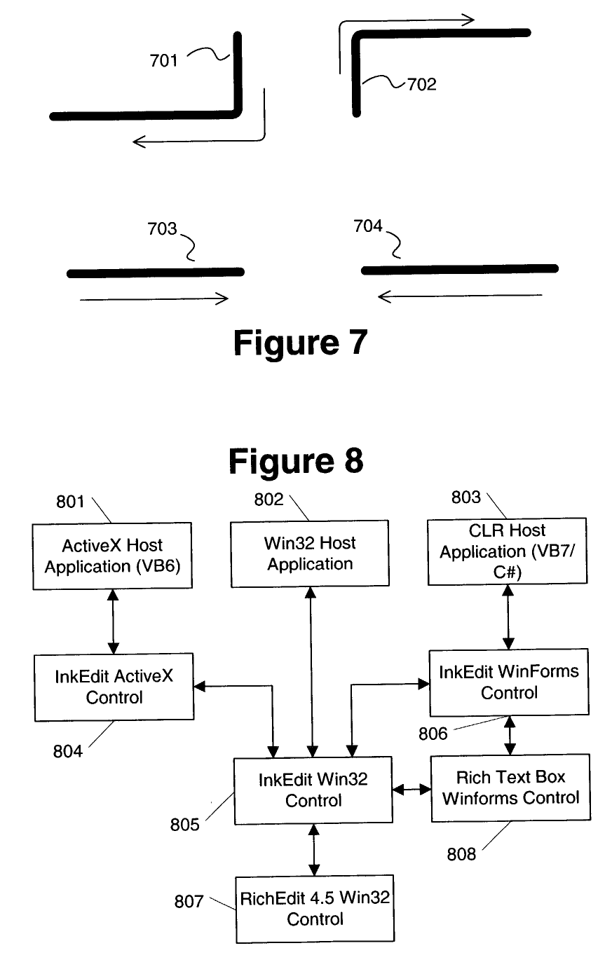

The InkEdit control exposes a variety of functionality to the user through its application programming interface (API). Depending upon the host application, various flavors of the InkEdit API may be provided. Referring to FIG. 8, an illustrative system may include one or more of the following: An ActiveX Host Application 801, a Win32 Host Application 802, and/or Common Language Runtime (CLR) Host Application 803. In addition, an InkEdit ActiveX control 804 may be defined and may interface with the ActiveX Host Application 801. An InkEdit Win32 control 805 may further be defined and may interface with the Win32 Host Application 802. An InkEdit WinForms control 806 may be defined and may interface with the CLR Host Application 803. Finally, a RichEdit 4.5 Win32 control 807 may be defined that interfaces with any or all of the various flavors of InkEdit controls 804, 805, 806. The InkEdit Win32 control 805 may be the basis for the other two controls (ActiveX control 804 and Winforms control 806). In one embodiment, key functionality may be implemented in the Win32 control 805 such as the collection of ink, the interaction with the recognizer(s), and/or subclassing the RichEdit Win32 control 807. The ActiveX InkEdit control 804 may use C++ classes defined by the Win32 InkEdit control 805 and may build on that functionality to create ActiveX support. The Winforms InkEdit control 806 may derive from a Winforms RichTextBox 808 and may extend it with inking functionality as discussed herein. The Winform InkEdit control 806 may extend functionality by, e.g., first loading a Win32 InkEdit control instead of the RichEdit control and adding new methods, properties, and/or events as desired on top of the existing API elements provided by the RichTextBox 808. Note that FIG. 8 depicts an illustrative set of relations between controls in various hosting environments, and as such the arrows between the controls are not intended to be limiting in any way.

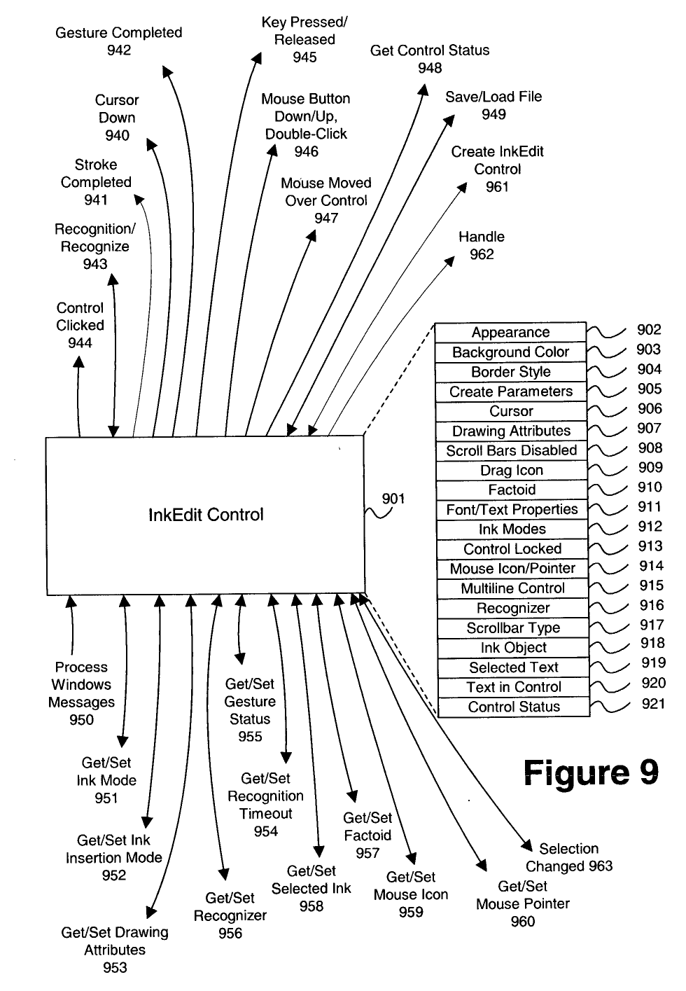

An illustrative API for the InkEdit control is now discussed with reference to FIG. 9. In FIG. 9, an InkEdit control 901 is represented by a box, and various elements (or functionally-grouped elements) of an API are shown as labeled arrows 940-960 emerging from and/or entering the box representing the InkEdit control 901. In general, arrows entering the InkEdit control 901 box refer to API elements (or functionally-grouped elements) that for the most part modify the InkEdit control 901 (e.g., by changing one of its properties) and/or otherwise provide information to the InkEdit control 901. Arrows emerging from the InkEdit control 901 box refer to API elements (or functionally-grouped elements) that for the most part represent a flag or some other information that is provided by the InkEdit control 901 to its environment. However, the directions of the arrows are illustrative and not intended to be limiting, and so an arrow entering the InkEdit control 901 is not prevented from also representing information provided by the InkEdit control 901 to its environment. Likewise, an arrow emerging from the InkEdit control 901 is not prevented from also modifying or providing information to the InkEdit control 901. FIG. 9 further shows a plurality of properties 902-921 of the InkEdit control 901. The below-discussed API elements may be utilized in any combination or subcombination for any flavor of an InkEdit-type control, including but not limited to the Win32, ActiveX, and .NET flavors discussed herein.

The InkEdit API in the illustrative embodiment has some or all of the following enumerations and structures (not shown), in any combination or subcombination. For example, an appearance enumeration defines one or more values that specify whether the InkEdit control 901 appears flat or in three-dimensional when displayed. A border-style enumeration defines one or more values that specify whether the InkEdit control 901 has a border. An ink-mode enumeration defines one or more values that specify the collection mode settings for drawn ink—whether ink collection is disabled, whether only ink is to be collected, or whether both ink and gestures are to be collected. An insert-mode enumeration defines one or more values that specify how ink is inserted onto the InkEdit control 901, either as ink or as recognized text. An InkEdit status enumeration defines one or more values that specify whether the InkEdit control 901 is idle, collecting ink, or recognizing ink. A load/save enumeration defines one or more values that specify whether a file is loaded and/or saved as a Rich Text Format (RTF) file, a text file, or a file in other format. A mouse-button enumeration defines one or more values that specify which mouse button was, or is being, pressed. Note that, unless otherwise specified, all references to a mouse or a mouse button herein may equally apply to a stylus and a stylus button. A scroll-bars enumeration defines one or more values that specify whether the InkEdit control has horizontal and/or vertical scrollbars. An alignment enumeration defines one or more values that specify whether a paragraph as displayed is aligned along the left or right margins of the InkEdit control, or between the left and right margins. A stroke-information structure contains information about a specific stroke, such as which cursor was used to create the stroke and where the stroke is stored (e.g., as a particular stroke object). A gesture-information structure contains information about a specific gesture, such as which cursor was used to create the gesture, the strokes that make up the gesture, and/or where the gesture is stored (e.g., as a particular gesture object). The stroke-information and gesture-information structures may be used with particular success in the Win32 flavor of the InkEdit control. A recognition-results structure contains information regarding the results of text recognition and is send in response to a recognition result being ready. The notification as to where some or all of these herein-dscussed structures are used may be provided via, e.g., a separate notification message.

The InkEdit API in the illustrative embodiment also has one or more of the following properties, in any combination or subcombination, that can be set and that can return the information they represent. For example, an appearance property 902 represents whether the InkEdit control 901 is displayed as being flat or in three dimensions. A background-color property 903 represents the background color for the InkEdit control 901. A border-style property 904 represents whether the InkEdit control 901 has a border. A create-parameters property 905 represents creation parameters when the InkEdit control 901 handle is created. A cursor property 906 represents the cursor that is displayed when the mouse pointer is over the InkEdit control 901. Drawing-attributes properties 907 represent the default drawing attributes to use when drawing and displaying ink (ink that has not yet been recognized as text) in the InkEdit control 901 or the drawing attributes to apply to ink as it is drawn. A scroll-bars-disabled property 908 represents whether scroll bars in the InkEdit control 901 are enabled or disabled. A drag-icon property 909 represent the icon to be displayed as the pointer in a drag-and-drop operation. A factoid property 910 represents the factoid (discussed further herein) that a recognizer uses to constrain its search for the recognition result. Various font and text properties 911 represent the font of the text displayed by the InkEdit control 901, as well as the font name and size of the currently-selected text or at the insertion point. Other font and text properties 911 represent whether the currently-selected text (or at the insertion point) is bold, italicized, or underlined. Still other font and text properties 911 represent whether the currently-selected text (or at the insertion point) appears on the baseline, as superscript, or as subscript, the alignment of the same, as well as the color of the currently-selected text or at the insertion point. Various ink-mode properties 912 represent how ink is collected when drawn on the control and whether ink collection is disabled, whether only ink is to be collected, or whether both ink and gestures are to be collected. A control-lock property 913 represents whether the contents of the InkEdit control 901 can be edited. Various mouse properties 914 represent the current custom mouse icon to be displayed and the type of mouse pointer displayed when the mouse pointer is over the graphical depiction of the InkEdit control 901. A multiline property 915 represents whether the InkEdit control 901 is a multiline control. Various recognizer properties 916 represent which recognizer is to be used for recognition, and the amount of time after an ink stroke has ended that text recognition is to begin. A scrollbar property 917 represents the type of scrollbars to display in the InkEdit control 901. An ink-object property 918 represents the Ink object(s) that are within the currently-selected text. Setting this ink-object property may cause the current selection to be replaced with the results of the recognition from recognizing the list of ink objects passed in. Various selected-text properties 919 represent the currently-selected text within the InkEdit control 901, the number of characters selected, the selected Rich Text Format (RTF) formatted text, and the starting point of the selected text. Various text-in-control properties 920 represent the current text displayed in the text box of the InkEdit control 901 as well as the text in the InkEdit control 901 including all RTF formatted codes. A status property 921 represents whether the InkEdit control 901 is idle, collecting ink, or recognizing ink.

The InkEdit API in the illustrative embodiment also has a plurality of associated messages, events, and methods, in any combination or subcombination. Since the InkEdit control is a super class of the RichEdit control, every RichEdit message is passed directly on (in most cases) to have the same effect as in RichEdit. This also applies to event notification messages, which notify the InkEdit control's parent window that a particular event has occurred.

For example, a cursor-down message 940 is sent responsive to the cursor tip (e.g., the tip of stylus 204) physically contacting the digitizing surface (e.g., surface 202). A stroke-completed message 941 is sent, and a stroke-completed event occurs, responsive to a stroke being completed. A stroke-completed method occurs responsive to a stroke-completed event occurring. A gesture-completed message 942 is sent responsive to a gesture being completed, which may be indicated by a gesture-completed event.

The InkEdit API may further have recognition-related events, methods, and messages 943. Such recognition-related messages are sent responsive to recognition having occurred, or get or set the recognizer that is used. Another recognition-related message specifically forces recognition prior to the recognition timeout would otherwise cause recognition to occur. Recognition-related events occur responsive to an application-specific gesture being recognized, and in response to recognition in general. Recognition-related methods occur responsive to the recognition event being raised, or specify that a collection of strokes should be recognized and that recognition results are to be returned.

The InkEdit API may further have an event 944 that occurs responsive to the InkEdit control 901 being clicked upon, events 945 that occur responsive to a key being pressed or released, events 946 that occur responsive to the mouse pointer and/or stylus being over the InkEdit control 901 and being pressed, released, or double-clicked, and an event 947 that occurs responsive to the mouse pointer being moved over the InkEdit control 901.

The InkEdit API may further have a message 948 it uses for retrieving the status of the InkEdit control 901 based on the values defined in the InkEdit Status enumeration, methods 949 that load a specific type of file into the InkEdit control 901 or save the contents of the InkEdit control 901 to a specific type of file, and a method 950 for processing Windows messages.

The InkEdit API may further have messages 951 that retrieve or set the inking mode of the InkEdit control 901 based on the values defined in the InkMode enumeration, and messages 952 that retrieve or set the ink insertion mode of the InkEdit control 901, based on the values defined in the InkInsertMode enumeration.

The InkEdit API may further have messages 953 that retrieve the current drawing attributes or set the future drawing attributes to be used in the InkEdit control 901, and messages 954 that retrieve or set the recognition timeout of the InkEdit control 901. The recognition timeout may be measured in, e.g., milliseconds.

The InkEdit API may further have gesture-status-related messages and methods 955. Gesture-status-related messages are defined that retrieve or set the gesture status for the InkEdit control 901. Gesture-status-related methods use the state of the gesture status to limit the set of gestures that may be recognized by the InkEdit control 901.

The InkEdit API may further have messages 956 that retrieve or set the recognizer to be used by the InkEdit control 901, messages 957 that retrieve or set the factoid to use for recognition, messages 958 that retrieve or set the currently-selected ink, messages 959 that retrieve or set the mouse icon that is displayed, and messages 960 that retrieve or set the mouse pointer to be displayed. The InkEdit API may further have a constructor 961 for creating a new InkEdit control, and a method 962 that occurs when a handle is created for the InkEdit control 901. In the NET flavor of the InkEdit control, this method may be considered a constructor. the InkEdit API may further have a selection-changed event that occurs responsive to the selection of text within the control changing. While illustrative systems and methods as described herein embodying various aspects of the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Although the invention has been defined using the appended claims, these claims are illustrative in that the invention is intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It is intended that the written description of the invention contained herein covers all such modifications and alterations. Also, it should be recognized that although various names of objects and other API elements are provided herein, such names are merely illustrative and any names may be used without departing from the scope of the invention.

Using a stylus-based input system has associated benefits and detriments. One area of overlap is the dual-functionality of a stylus. Here, the stylus handles both data entry (similar to a keyboard) and control inputs (like that of a mouse). One of the difficulties associated with data entry for a stylus is the problem of a data entry region being too small accepted a users' handwriting. For example, if a user is filling out and online form, the data entry region's may be appropriately sized for receiving and display from a keyboard but are too small to act as a handwriting input area for a user.

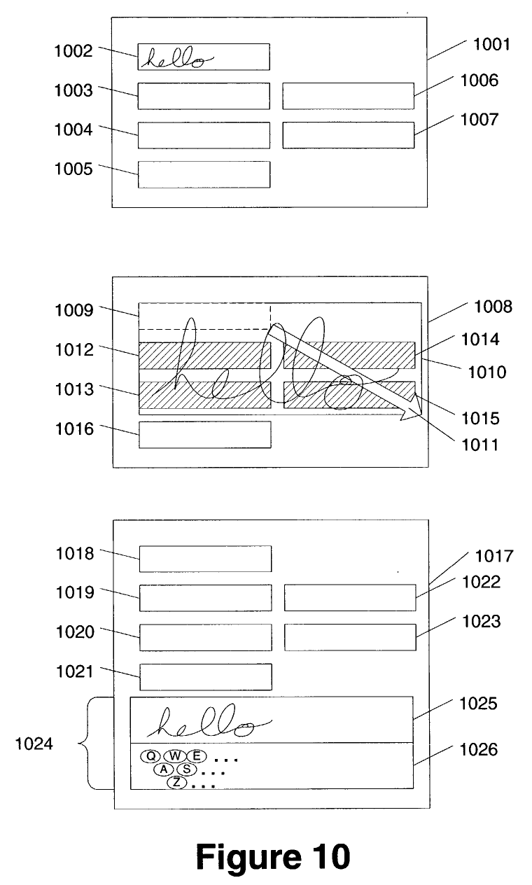

FIG. 10 and various regions that may be used to capture accordance with aspects of the present convention. While the following figures are described in relation to the preceding InkEdit control, it is appreciated that other edit controls may be used with different functionality. Thus, the disclosed ink edit control is but one example of how an edit control may be used.

In region 1001, a variety of ink/text input sub-regions 1002-1007 are shown. Region 1002 includes handwritten ink with the word “hello.” To create the ink that is captured in region 1002, a user would have needed to write within 1002. The difficulty writing in such a small area is that users need within the bounds of region 1002. Further, it may be very difficult to write small enough to contain the electronic ink within the bounds of region 1002 due to external circumstances, for example jittery hands while riding on a bus or even when walking.

Region 1008 shows an alternative input region for original input region 1002. Here, original region 1002 has been expanded (arrow 1011) from its original size region 1009 (shown as a broken box) larger size as shown by region 1010. Region 1010 overlies previous input regions (1012, 1013, 1014, and 1015), as are shown by their hatched pattern. In region 1010, a user is provided with an ear interface in which to be able to input ink. Here for example a user may use region 1010 in which to write the word “hello.” The ink from region 1010 may then be shrunk down and input into the field 1002, as if the writer had been able to completely write within the bounds of region 1002. As the expanded input region 1010 is no longer needed, it to may be shrunk down to the 1002 size. While region 1002 and region 1010 are shown in FIG. 10 in registration with respect to their top left corner, this registration is not required, but only shown for illustrative purposes. For example, region 1010 may only portion of region 1002, or may be separate from region 1002. Finally, if the handwriting recognition is in use, the ink input into area 1010 may be recognized and the corresponding text inserted into region 1002.

A third version of an input region is shown by region 1024 in display 1017. Here, ink input region 1025 is juxtaposed to a soft keyboard display 1026. This region 1024 may be invoked by, for example, tapping on region 1018, hovering over region 1018, or by otherwise requesting input region 1024 to appear. Other regions are shown as well they also a folk region 1024, including regions 1019, 1020, 1021, 1022, and 1023. This third input region 1024 may be invoked when a user is having difficulty invoking expanded region 1010, when having difficulty writing in region 1002, or when attempting to enter very specific information that may have limits on the number of times they may be input (for example, user names and passwords).

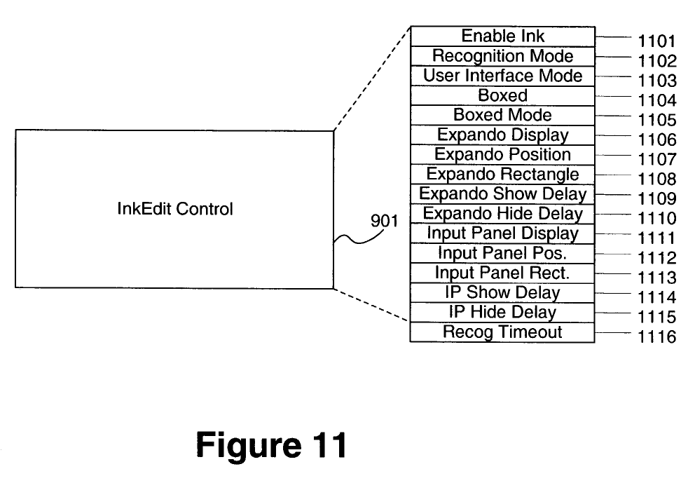

FIG. 11 shows additional properties that relate to the ink input system for the ink edit control of FIG. 9. These properties permit a developer to control how the input mechanisms function. A first property may be included as enable ink 1101, a Boolean value that indicates when mouse and or ink strokes are to be treated as electronic ink or as mouse control commands. Another property is the ink modes property 912 from FIG. 9 that controls how can input information is placed into a input region. This property may have two enumerated values: “text” or “ink.”

In “text” mode, the control inserts text into an input region regardless of whether the user entered the information via a keyboard or handwriting (by means of a mouse or pen). In “ink” mode, the control inserts text into the input region if entered by means of a keyboard, or inserts an image of the user's handwriting if entered by means of a mouse or pen.

Recognition mode property 1102 has two values: timeout recognition and background recognition. When in the time out mode a user is able to write comfortably and then pause to allow recognition to occur, and finally text/ink to be inserted into an input region. After the recognition is complete, that collected strokes are discarded and not used for recognition of subsequent strokes. In an alternate example however, the strokes may be maintained for later recognition purposes and/or correction. During background recognition, collected strokes are not discarded as quickly as into the time out mode. This always the user to enter longer sequences of handwriting (for instance, long interrupted with delays). Recognition occurs and text is inserted as a user continues to write. The text may be modified dynamically as the recognition engine obtains more information about context, punctuation, and other recognition clues as well as additional handwriting. In one example if the user starts writing significantly to the left of the last strokes, previously collected ink may be hidden from display.

Recognition timeout property 1116 provides an indication of when recognition should occur. If the value of the recognition timeout property 1116 is “timeout,” the recognition occurs after a user has delayed for a timeout interval (for example, two seconds) prior to commencing handwriting recognition. The value of the recognition time out property 16 is “background”, the recognition occurs in the background and the strokes are maintained for a longer period of time (for example, 30 seconds).

The factoid property 910 may also be used to specify the type of input expected to assist the recognizer in recognition. Alternatively, the InkEdit control may expose a recognition context property that encapsulates the recognizer and factoid properties, and may further include other recognition behavioral attributes.

User interface mode property 1103 provides a description of the type of default input region display type for an input region. For example, the input region size may be fixed for input regions like input region 1002, check boxes or radio buttons. The user interface mode property 1103 may also relate to the expanding input region 1010. Finally, the user interface mode property 1103 may relate to the input panel 1024. The input panel 1024 may be useful for specialized input scenarios including passwords, numbers, and the like.

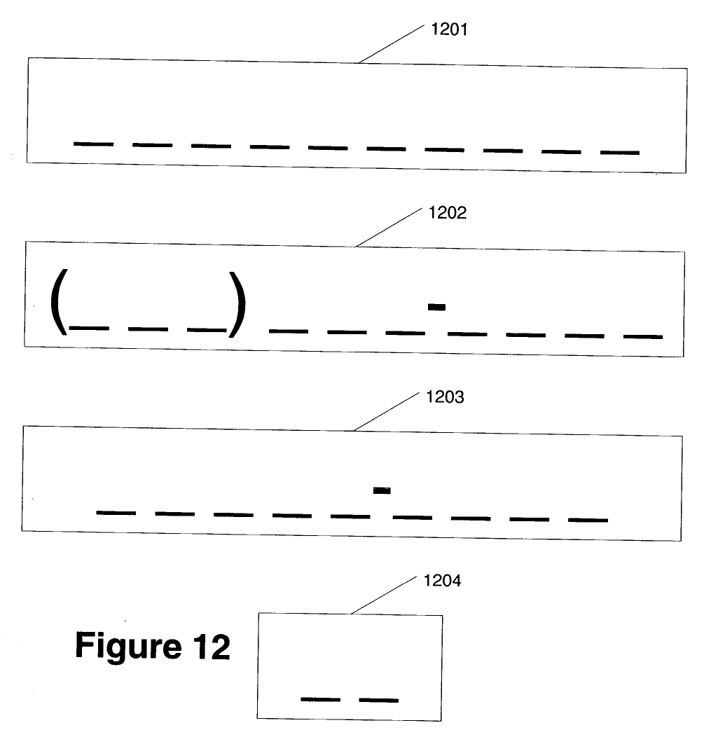

The boxed property 1104 describes whether the recognition should occur on a word-by-word basis or on a letter-by-letter basis. The recognition timeout may be set small (for example, 0.25 ms). The general recognition may be the word-by-word of recognition type. However, when an input region includes a boxed mode identifier, the box may be separated into sub-cells with each input occurring in a separate cell. The sub-cells are sent to the recognizer one letter at a time. One benefit of letter-by-letter recognition is the ability to enter some strings with less difficulty. An example of such strings are numeric strings as shown in FIG. 12. In input boxed 1201, a user enters a word one character at a time above each underscore. In box 1202, a user enters a telephone number. In box 1203, a user enters a ZIP code plus 4 extension. In box 1204, a user enters a state abbreviation. The boxed, box mode, and related properties and behaviors may be referred to as wrapping the “guide” property of the recognizer context.

Another property is the boxed mode property 1105. The boxed mode property 1105 indicates where and how sub-cell separations should be displayed for a user. The sub-cell separations may be rendered consistent with the control's border style, color, and thickness.

In some examples, a single “character” or glyph may be a gesture. In other examples, this glyph may be an actual word in languages that support symbolic characters. In this scenario, symbolic characters may be recognized in a boxed mode.

Properties 1106-1110 relate to the expandable input region 1010. One property of the expandable region 1010 is an expandable (referred to herein as “expando”) display in which the display may be displayed as transparent, semitransparent, or opaque. Another property is the expando position 1107 that permits the position of the display 1010 to be absolute with respect to a page or relative with respect to an input region. A further property includes the expando rectangle property 1108 that defines the location of the expanding input region 1010. If the expando position property 1107 is relative, the rectangle of the expando rectangle 1108 is treated as offset from the control's normal input window 1002. If the expando position property 1107 is absolute, then the rectangular dimensions from expando rectangle 1108 are treated as relative to the upper left corner of a containing window. Into a further example, if no expando rectangle 1108 is specified, the expando rectangle 1108 may be calculated as a 50% vertical increase and a minimum of a 1 inch wide input region for region 1010.

Another property is the expando show delay property 1109. This property provides a delay in milliseconds during which a stylus hovers over input region 1002 before expanding region 1002 into region 1015. Expando hide delay property 1110 provides the delay in milliseconds that a pen hovers over a normal control rectangle before input region 1010 shrinks back to the control's normal rectangle size 1002. Alternatively, the display of a widget may be used when the input stylus hovers over a region in order to display which input region will expand and/or become visible. In other words, the hover area does not have to be the control's normal rectangle.

The following properties relate to the control of input panel 1024. The next property is the input panel display property 1111, which provides an identifier to which text input should be displayed. A default input panel may be chosen. However, specific text input panel's may be used for special purposes (passwords, for example). The next property is the input panel position property 1112, which indicates the position of the text input panel is relative or absolute.

Another property is the input panel rectangle 1113 that specifies the location of the input panel. If the input panel position property 1112 is relative, then the dimensions for the input panel specified in property 1113 are treated as offsets from the control's normal rectangle. If the input panel position property 1112 is “automatic”, then the rectangular dimensions for the input panel in property 1113 are applied relative to a corner of a containing window. If no rectangle is specified, the input panel rectangle property 1113 may be calculated for example as a 50% vertical increase and about a one to three (or so) inch wide region over the initial size of input region 1002.

The final properties of input panel show delay 1114 input panel hide delay 1115 are the delays in milliseconds that a stylus hovers over a control before input region expands into an input panel or shrinks back to the controls normal rectangle.

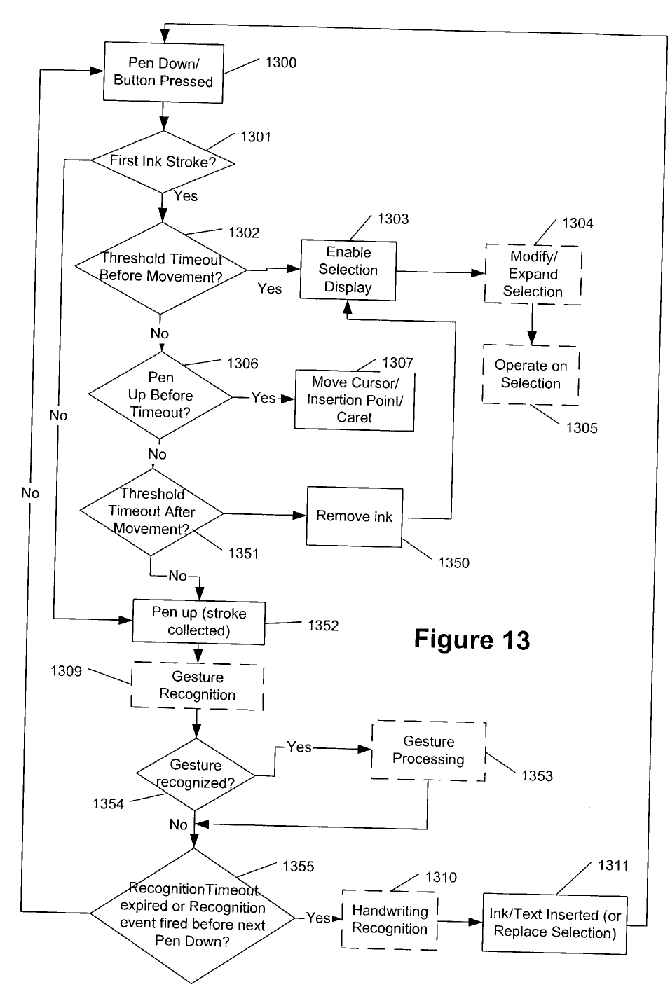

FIG. 13 shows an illustrative process for determining when an insertion point has been placed, a selection has been started, or inking has been started. This process is complementary to the above description, but does not need rely on the particulars of the above. Other ink controls may be used as well or in place of the above controls. A pen down or button pressed event is received in step 1300. If this is the first stroke in a new area, then the process may advance to step 1302, otherwise it may advance to step 1308. In step 1302, it is determined whether the pen moved prior to a timeout. If yes, then the user held the pen in place for a timeout as set forth in 1302. In response, in step 1303, the system enables a selection display. Optional steps may be included as steps 1304 (which includes modifying/expanding a selection display) and 1305 (which includes operating on the selection).

If there was movement prior to the timeout in step 1302, then the system in step 1306 determines whether a pen up event was received prior to the timeout. If yes, then in step 1307, the cursor/insertion point/caret is moved to the location of the pen up event. If the timeout in step 1306 occurred prior to the pen being raised, then it is checked whether a threshold timeout occurs after movement of the pen in step 1351. If the threshold timeout occurs, then the deposited ink is removed in step 1350. If not, then the system understands the pen to be up and moves to step 1352, and the stroke from the series of points may be created and may be stored as a stroke object. If so, then Optional steps include performing gesture recognition 1309 as shown in a broken box. In step 1354, if a gesture is recognized, then it is processed in step 1353. If not, then it is checked whether a recognition timeout expires and/or a recognition event is fired before the next pen down in step 1355. If so, then optionally, handwriting recognition may occur in step 1310 and finally, the text/ink is inserted in step 1311. An additional time out may be included at this point, after the ink strokes are received but before the ink is recognized. This alternatively may take the form of replacing a previously designated with ink/text.

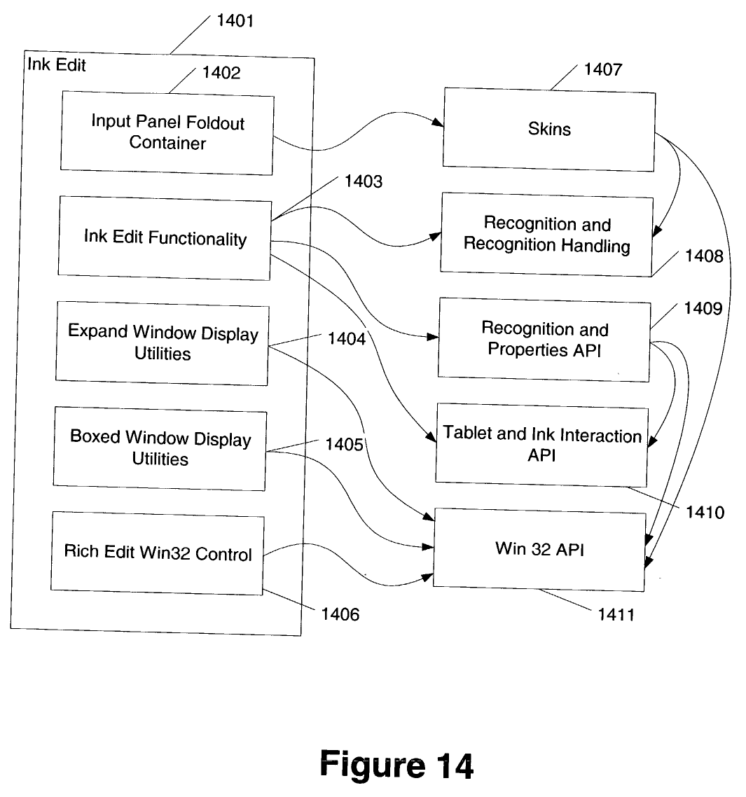

FIG. 14 shows relationships between the ink control 1401 and various other interfaces and datasets. The ink edit control 1401 includes an input panel fold-out container 1402, ink edit functionality 1403, expand window display utilities 1404, boxed window display utilities 1405, and a rich edit Win32 control 1406. These aspects of the edit control 1401 interactive with the datasets and interfaces 1407-1411. For example, the input panel foldout container 1402 interacts with skins 1407. Ink edit functionality 1403 interacts with recognition and recognition handling engine 1408, recognition and properties API 1409, and ink interaction API 1410. The expand window display utilities 1404, the window display utilities 1405, and the rich edit Win32 control 1406 exchange information with the Win32 API 1411.

While illustrative systems and methods embodying the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Although the invention has been defined using the appended claims, these claims are illustrative in that the invention is intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It is intended that the written description of the invention contained herein covers all such modifications and alterations. In addition, it should be recognized that although various names of objects, enumerations, method, and properties are provided herein, such names are merely illustrative and any names may be used without departing from the scope of the invention.

We claim:

1. A user interface for receiving input information comprising:
a first displayed region; and
a second displayed region,
wherein said first displayed region expands into said second region upon interaction with said first displayed region, and
wherein ink and/or text entered into said second display region is input into said first displayed region.

2. The user interface according to claim 1, wherein said interaction with said first displayed region is a user hovering a stylus over said first displayed region.

3. A user interface for receiving input information comprising:
a first displayed region; and
a second displayed region,
wherein said second displayed region is displayed upon interaction with first displayed region, said second displayed region includes a third region to receive handwritten ink and/or a fourth region including a soft keypad, and
wherein ink and/or text entered into said second display region is input into said first displayed region.

4. In a control, a process for providing input regions for receiving ink and or text comprising the steps of:
receiving user interaction with a first displayed region;
generating a second displayed region;
receiving ink and/or text in said second displayed region;
placing at least one of ink and/or text in said first displayed region after closing said second region.

5. The process according to claim 4, wherein said second displayed region is an expanded version of said first displayed region.

6. The process according to claim 4, wherein said second displayed region includes a third region for receiving handwritten ink, and a fourth region displaying a soft keypad.

7. The process according to claim 4, further comprising the step of:
performing handwriting recognition on said ink received second displayed region,
wherein said placing step includes placing text corresponding to said ink into said first displayed region.

8. A graphical user interface for receiving handwritten ink comprising:
a first region, said first region being selectable whether or not to receive handwritten ink.

9. A graphical user interface for receiving handwritten ink comprising:
a first region, said first region having selectable properties.

10. The graphical user interface according to claim 9, wherein at least one of said properties includes selectable properties, of which one of the selectable properties is a type of recognition mode.

11. The graphical user interface according to claim 9, wherein at least one of said properties includes specification of a user interface mode.

12. The graphical user interface according to claim 9, wherein at least one of said properties includes specification of a boxed input mode.

13. The graphical user interface according to claim 9, wherein at least one of said properties includes specification of how a second region will appear when activated.

14. The graphical user interface according to claim 13, wherein said second region is an expanding display.

15. The graphical user interface according to claim 13, wherein said second region is a combination of a handwriting receiving region and a soft keypad.

16. The user interface according to claim 1, wherein said ink and/or text entered into said second display region is input into said first displayed region upon the closure of said second to region.

17. The graphical user interface according to claim 9, wherein at least one of said properties includes selectable properties.

18. The graphical user interface according to claim 3, wherein said ink and/or text entered into said second display region is input into said first displayed region upon the closure of said second to region.
